(19) United States
(12) Patent Application Publication
(10) Pub. No.: US 2022/0301183 A1
(43) Pub. Date: Sep. 22, 2022

(54) METHOD AND APPARATUS FOR TRACKING OBJECT, ELECTRONIC DEVICE, AND READABLE STORAGE MEDIUM

(71) Applicant: Beijing Baidu Netcom Science Technology Co., Ltd., Beijing (CN)

(72) Inventors: Shuai KANG, Beijing (CN); Xiangbo SU, Beijing (CN)

(21) Appl. No.: 17/836,507

(22) Filed: Jun. 9, 2022

(30) Foreign Application Priority Data
Aug. 24, 2021 (CN) 202110973091.7

(51) Int. Cl. G06T 7/20; G06T 7/70

(52) U.S. Cl. CPC G06T 7/20; G06T 7/70; G06T 2207/20221; G06T 2207/20084

(57) ABSTRACT

A method and apparatus for tracking an object, an electronic device, and a readable storage medium are provided. The method can include: determining an object re-identification feature of each target object in a target frame image, the object re-identification feature comprising position information of each target object; and performing object tracking based on the object re-identification feature of each target object.

### CROSS-REFERENCE TO RELATED APPLICATIONS

The present application claims the priority of Chinese Patent Application No. 202110973091.7, titled “METHOD AND APPARATUS FOR TRACKING OBJECT, ELECTRONIC DEVICE, AND READABLE STORAGE MEDIUM”, filed on Aug. 24, 2021, the content of which is incorporated herein by reference in its entirety.

### TECHNICAL FIELD

The present disclosure relates to a technical field of artificial intelligence, particularly relates to computer vision and deep learning technologies, and may be specifically used in smart city and smart traffic scenarios.

### BACKGROUND

Object tracking is an important issue in a field of computer vision, and is currently widely used in fields such as sports event rebroadcasting, security monitoring and unmanned aerial vehicles, autonomous vehicles, and robots. How to improve a performance of object tracking has become an issue attracting extensive attentions.

### SUMMARY

The present disclosure provides a method for tracking an object, an apparatus for tracking an object, an electronic device, and a readable storage medium.

According to a first aspect of the present disclosure, a method for tracking an object is provided, including:

determining an object re-identification feature of each target object in a target frame image, the object re-identification feature comprising position information of each target object; and

performing object tracking based on the object re-identification feature of each target object.

According to a second aspect of the present disclosure, an apparatus for tracking an object is provided, including:

a determining module configured to determine an object re-identification feature of each target object in a target frame image, the object re-identification feature comprising position information of each target object; and

a tracking module configured to perform object tracking based on the object re-identification feature of each target object.

According to a third aspect of the present disclosure, an electronic device is provided. The electronic device includes:

at least one processor; and

a memory communicatively connected to the at least one processor; where

the memory stores instructions executable by the at least one processor, and the instructions are executed by the at least one processor, such that the at least one processor can execute the above method.

According to a fourth aspect of the present disclosure, a non-transient computer readable storage medium storing computer instructions is provided, where the computer instructions are used for causing a computer to execute the above method.

According to a fifth aspect of the present disclosure, a computer program product is provided, including a computer program, where the computer program, when executed by a processor, implements the above method.

It should be understood that contents described in the SUMMARY are neither intended to identify key or important features of embodiments of the present disclosure, nor intended to limit the scope of the present disclosure. Other features of the present disclosure will become readily understood in conjunction with the following description.

### BRIEF DESCRIPTION OF THE DRAWINGS

The accompanying drawings are used for better understanding of the present solution, and do not impose any limitation on the present disclosure. In the accompanying drawings:

FIG. 1 is a schematic flowchart of a method for tracking an object according to the present disclosure;

FIG. 2 is a schematic structural diagram of an apparatus for tracking an object according to the present disclosure; and

FIG. 3 is a block diagram of an electronic device configured to implement embodiments of the present disclosure.

### DETAILED DESCRIPTION OF EMBODIMENTS

Example embodiments of the present disclosure are described below with reference to the accompanying drawings, including various details of the embodiments of the present disclosure to contribute to understanding, which should be considered merely as examples. Therefore, those of ordinary skills in the art should realize that various alterations and modifications may be made to the embodiments described here without departing from the scope and spirit of the present disclosure. Similarly, for clearness and conciseness, descriptions of well-known functions and structures are omitted in the following description.

### Embodiment I

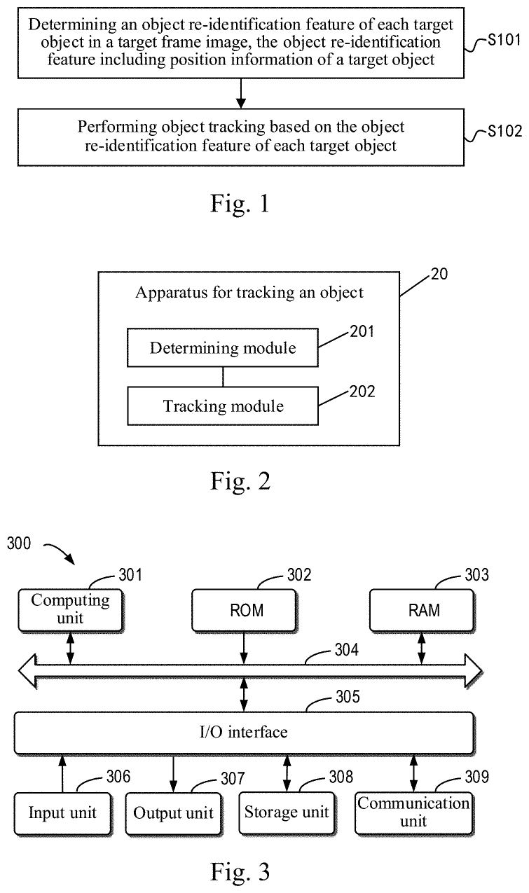

FIG. 1 shows a method for tracking an object provided in an embodiment of the present disclosure. As shown in FIG. 1, the method includes:

Step S101: determining an object re-identification feature of each target object in a target frame image, the object re-identification feature including position information of the target object; and

Step S102: performing object tracking based on the object re-identification feature of each target object.

Object tracking is an important issue in the field of computer vision, and is currently widely used in the fields such as sports event rebroadcasting, security monitoring and unmanned aerial vehicles, autonomous vehicles, and robots. Object tracking may include single object tracking and multiple object tracking (MOT). A main task of the multiple object tracking includes positioning multiple objects of interest, maintaining IDs of the multiple objects, and recording trajectories of the multiple target objects. If IDs of target objects in different target frame images are identical, the target objects are considered to be the same target object.

The target frame image may be an image extracted from collected videos, and the target object may be a vehicle, a person, an animal, or the like, where the collected videos may be videos collected in a scenario, such as smart traffic or smart monitoring. The collected videos may be collected by the same image collecting device, or may be collected by different image collecting devices.

Person re-identification (Re-ID) is a technology for determining whether there is a specific person in an image or video sequence using a computer vision technology. The present disclosure is not limited to person re-identification, but may include the identification of other target objects. That is to say, the target object re-identification in the present disclosure includes determining whether there is a specific object in an image or video sequence using the computer vision technology.

As an important step in object tracking, the data association step includes associating a target object in a current frame with an object in a previous frame. If the object in the current frame and the object in the previous frame are the same object, the same ID as the target object in the previous frame may be assigned. If the object in the current frame does not exist in the previous frame, the object in the current frame is determined to be a new object, and a new ID may be assigned.

The data association step is implemented by matching of the object re-identification feature (Re-ID feature), where matching is performed on an extracted re-identification feature of the target object in the current frame and a re-identification feature of the target object in the previous frame. If a corresponding vector distance satisfies a predetermined condition (such as being less than a predetermined threshold), the two objects may be considered as the same one. If the corresponding vector distance does not satisfy the predetermined condition (such as exceeding the predetermined threshold), the two objects may be considered as being different. Further, position information of the same object may be classified into the same category, and trajectory data of a corresponding object may be generated based on position information, in the same category, of the object.

In an existing technology, a re-identification feature as applied is only an appearance feature (visual feature) or a motion feature, while the object re-identification feature of the present disclosure is a feature in which a position of the target object being encoded.

As an advantage of introducing a position feature of the target object, for example, for target objects A and B with similar appearances, correct IDs of the target objects A and B are 23 and 24, respectively. Since A and B have similar appearances, and the re-identification feature is the appearance feature using the existing technology, an incorrect ID switch may occur during data association. That is because a re-identification feature of the target object A is likely to match a historical re-identification feature of a tracker corresponding to the ID of (i.e., a corresponding vector distance is less than the predetermined threshold), and a re-identification feature of the target object B is likely to match a historical re-identification feature of a tracker corresponding to the ID of 23. That is to say, the ID of the target object A is determined to be 24, and the ID of the target object B is determined to be 23. The re-identification feature used for data association in the present disclosure introduces position features of the target objects, thereby reducing the occurrence of incorrect ID switch. For the same object, an occurrence number of its ID switch caused by the misjudgment based on a tracking algorithm is referred to as ID sw., and an ideal number of ID switches in the tracking algorithm should be 0.

Compared to object tracking in an existing technology in which a re-identification feature used for data association is an appearance feature, in embodiments of the present disclosure, an object re-identification feature of each target object in a target frame image is determined, the object re-identification feature including position information of the target object; and object tracking is performed based on the object re-identification feature of each target object. That is, the re-identification feature used for data association in object tracking includes position information of the target object, thereby improving a distinction degree between the target object and the background.

For target objects with similar appearances, it is possible to reduce the occurrence of incorrect ID switch during object tracking since the position information of the target objects is considered. For example, for target objects A and B with similar appearances, correct IDs of the target objects A and B are 23 and 24, respectively. Since A and B have similar appearances, an incorrect ID switch may occur during data association, because a re-identification feature of the target object A is likely to match a historical re-identification feature of a tracker corresponding to the ID of 24, and a re-identification feature of the target object B is likely to match a historical re-identification feature of a tracker corresponding to the ID of 23. That is to say, the ID of the target object A is determined to be 24, and the ID of the target object B is determined to be 23. The re-identification feature used for data association in the present disclosure introduces position features of the target objects, thereby reducing the occurrence of incorrect ID switch.

The embodiment of the present disclosure provides a possible implementation, in which the position information of the target object is center point information of the target object.

Specifically, the position information of the target object may be represented by a center point position of the target object, or may be represented by other positions, such as multiple edge position points of the target object or multiple position points in a middle area of the target object.

Specifically, when a corresponding neural network model is trained, training samples as used are correspondingly annotated with the position information of the target objects. For example, the center point position of the target object may be manually annotated, and the center point position may be determined by manual estimation. In addition, in order to realize accurate annotation of the center point position, the center point may be determined using a centroid determining algorithm, thereby extracting, in application, a corresponding position feature of the target object based on the trained model.

For the embodiment of the present disclosure, the position of the target object may be represented by the center point position of the target object, thereby not only introducing a global feature of the target object, but also preventing employing an edge position which may overlap with an edge position of another target object.

The embodiments of the present disclosure provide a possible implementation, in which determining the object re-identification feature of each target object in the target frame image includes:

determining a first re-identification feature of each target object in the target frame image, the first re-identification feature including a visual feature and/or a motion feature;

encoding a center point position of each target object based on a TransFormer encoder network, to obtain a center point encoding feature of each target object; and

performing fusing on the center point coding feature and the first re-identification feature of each target object to obtain the object re-identification feature of each target object.

Specifically, the first re-identification feature may include the visual feature (appearance feature) and/or the motion feature. That is to say, the first re-identification feature may include only one of the visual feature and the motion feature, or may include both of the visual feature and the motion feature. Specifically, the first re-identification feature may be obtained by fusing the extracted visual feature and the extracted motion feature. The motion feature of the target object may be extracted as per, e.g., an optical flow equation (OFE).

In principle, by the Transformer, position information of a sequence cannot be obtained by implicit learning. In order to process a sequence problem, in the Transformer, position encoding (Position Encode/Embedding, PE) is used to solve this problem. Further, absolute position encoding is used for ease of computation, i.e., each position in the sequence has a fixed position vector.

Specifically, the center point of the target object may be encoded as per the following equation:

$$P {E}_{( p o s , 2 i )} = sin ( \frac{p o s}{{10000}^{\frac{2 i}{{}^{d} model}}} ) \qquad ( equation 1 )$$

$${PE}_{( p o s , 2 i + 1 )} = cos ( \frac{p o s}{{10000}^{\frac{2 i}{{}^{d} model}}} ) \qquad ( equation 2 )$$

PE is a two-dimensional matrix; a dimension of the PE matrix is identical with that of an embedding matrix, and is assumed to be N*C; d_{model} denotes a dimension of a center point vector; pos is (0˜N-1), and denotes a position of a word in a sentence, where the word here refers to a center point, and the sentence refers to d_{model}, i.e., a position of a center point in d_{model}; i takes a value of (0˜C/2), and denotes a position of a word vector, i.e., a position of the center point vector in d_{model}. Then encoding is performed by selecting a sin or a cos function respectively based on the position pos and the odevity of i, to obtain a final PE matrix, and the PE matrix is incorporated to original pos embedding.

Specifically, the obtained center point coding feature and the first re-identification feature may be directly spliced to obtain the object re-identification feature; or may be linearly spliced based on weights of the center point coding feature and the first re-identification feature to obtain the object re-identification feature.

The embodiment of the present disclosure solves a problem of determining the object re-identification feature.

The embodiment of the present disclosure provides a possible implementation, in which the method includes:

determining the first re-identification feature of each target object in the target frame image using a model of object tracking by detecting.

The model of object tracking by detecting generally includes two independent models, namely an object detecting model and an association model. The object detecting model first delimits a candidate box of the target object in an image to position an object of interest; and then the association model extracts a re-identification feature (Re-ID feature) for each candidate box, and is linked to one of existing tracks based on corresponding a metric defined in view of feature.

The embodiments of the present disclosure improve an object re-positioning feature including the position feature using the model of object tracking by detecting, thereby reducing the occurrence of incorrect ID switch in the use of the original model of object tracking by detecting.

The embodiments of the present disclosure provide a possible implementation, in which the model of object tracking by detecting is a DeepSORT-based object tracking model, and the method includes:

determining candidate box information and the first re-identification feature of each target object based on a pre-trained object detection network model, the candidate box information including candidate box position information;

encoding a candidate box position corresponding to each target object based on the TransFormer encoder network, to obtain a position coding feature of each target object; and

performing fusing on the position coding feature and the first re-identification feature of each target object to obtain the object re-identification feature of each target object.

The pre-trained object detection network model may be a YOLO (You only look once) model, or may be other object detection models such as RCNN or Fast-RCNN. Based on the pre-trained object detection network model, information related to a candidate box and a first re-identification feature, i.e., a feature obtained by performing corresponding feature extraction on a determined candidate box, of the target object of interest may be detected and identified; where the information related to the candidate box specifically may include position information, length information, and width information.

Specifically, the candidate box position corresponding to each target object may be encoded based on the TransFormer encoder network, to obtain the position coding feature of each target object.

Specifically, the obtained position coding feature and the first re-identification feature may be directly spliced to obtain the object re-identification feature; or may be linearly spliced based on weights of the position coding feature and the first re-identification feature to obtain the object re-identification feature. The weights may be determined based on empirical values, or may be determined by training.

The core of Deep SORT includes two algorithms: Kalman filtering and Hungarian matching. By the Kalman filtering, it is possible to predict, based on a position of an object at a previous moment, a position of the object at a current moment, and to estimate the position of the object more accurately than a sensor (i.e., an object detector in object tracking, such as Yolo). The Hungarian algorithm solves an assignment problem, and is used for solving a problem of data association in multiple object tracking. Assuming that two detections both have highest similarities to a track a, how to determine a detection from the two detections to assign to the track a? In this case, an algorithm similar to Hungarian algorithm is required to be used for the assignment.

The optimization of DeepSORT is mainly performed based on a cost matrix in the Hungarian algorithm. An additional cascade matching is performed prior to IOU Match, using the appearance feature and a Mahalanobis distance. The matching refers to similarity computation and assignment between a current valid trajectory and a trajectory of a detected object. In SORT, the similarity computation of matching is only by using an overlap ratio in IOU between a prediction box and a current trajectory box as measurement. In DeepSORT, not only is motion information used, but also apparent information is added, and apparent similarity is computed to measure whether they are the same object.

The improvement of the present disclosure mainly lies in the re-identification feature used for data association, and other processing may be implemented by corresponding adjustment with reference to standard Deep SORT. The description will not be repeated here.

The embodiment of the present disclosure improves the object re-positioning feature including the position feature by the DeepSORT-based object tracking model, thereby reducing the occurrence of incorrect ID switch in the use of the original DeepSORT-based object tracking model.

The embodiments of the present disclosure provide a possible implementation, in which the method further includes:

determining the first re-identification feature of each target object in the target frame image using an object tracking model based on combined detection and tracking.

The core concept of object tracking based on combined detection and tracking is to simultaneously complete object detection and Re-ID embedding functions in a single network, thereby reducing a reasoning time period by sharing most computation. The improvement to the re-identification feature in the present disclosure may be applied to a corresponding object tracking model based on combined detection and tracking.

The embodiment of the present disclosure improves the object re-positioning feature including the position feature using the object tracking model based on combined detection and tracking, thereby reducing the occurrence of incorrect ID switch in the use of the original object tracking model based on combined detection and tracking.

The embodiments of the present disclosure provide a possible implementation, in which the object tracking model based on combined detection and tracking is a FairMORT-based object tracking model, and the method further includes:

extracting the first re-identification feature and a detection feature of each target object via a pre-trained encoder-decoder network of the FairMOT-based object tracking model;

performing Heatmap estimation based on each detection feature to obtain the center point position of each target object;

encoding the center point position of each target object based on the TransFormer encoder network, to obtain a position coding feature of each target object; and

performing fusing on the position coding feature and the first re-identification feature of each target object to obtain the object re-identification feature of each target object.

Specifically, the detection feature and the first re-identification feature (Re-ID feature) are extracted via the FairMOT encoder-decoder network.

Specifically, Heatmap, an object center offset, and a box size are predicted respectively based on the extracted detection feature using three parallel regression heads by an anchor-free approach. Specifically, in each head, 3×3 convolution (256 channels) is performed on an output feature map (Detection), and then a final object is generated through a 1×1 convolutional layer.

Heatmap Head is used for predicting a center position of an object. Center Offset Head is responsible for more precisely positioning an object. Box Size Head is used for estimating a height and a width of a target bounding box at each anchor point.

Specifically, the candidate box position corresponding to each target object may be encoded based on the TransFormer encoder network, to obtain the position coding feature of each target object.

Specifically, the obtained position coding feature and the first re-identification feature may be directly spliced to obtain the object re-identification feature; or may be linearly spliced based on weights of the position coding feature and the first re-identification feature to obtain the object re-identification feature. The weights may be determined based on empirical values, or may be determined by training.

FairMOT multiple object tracking significantly improves a tracking performance of a single-step method (i.e., combined detection and tracking) by de-anchoring, multi-layer feature aggregation, and low-dimensional feature learning. The improvement of the present disclosure lies in the improvement to the object re-positioning feature including the position feature using a FairMOT-based object tracking model, and other processing may be implemented by corresponding adjustment with reference to the standard Deep SORT. The description will not be repeated here.

The embodiment of the present disclosure improves the object re-positioning feature including the position feature using the FairMOT-based object tracking model, thereby reducing the occurrence of incorrect ID switch in the use of the original FairMOT-based object tracking model.

### Embodiment II

An embodiment of the present disclosure provides an apparatus for tracking an object. As shown in FIG. 2, the apparatus includes:

a determining module 201 configured to determine an object re-identification feature of each target object in a target frame image, the object re-identification feature including position information of the target object; and

a tracking module 202 configured to perform object tracking based on the object re-identification feature of each target object.

The embodiment of the present disclosure provides a possible implementation, in which the position information of the target object is center point information of the target object.

The embodiment of the present disclosure provides a possible implementation, in which the determining module includes:

a first determining unit configured to determine a first re-identification feature of each target object in the target frame image, the first re-identification feature including a visual feature and/or a motion feature;

a first encoding unit configured to encode a center point position of each target object based on a TransFormer encoder network, to obtain a center point coding feature of each target object; and

a first fusing unit configured to fuse the center point coding feature and the first re-identification feature of each target object to obtain the object re-identification feature of each target object.

The embodiment of the present disclosure provides a possible implementation, in which the determining module is specifically configured to determine the first re-identification feature of each target object in the target frame image using a model of object tracking by detecting.

The embodiment of the present disclosure provides a possible implementation, in which the model of object tracking by detecting is a DeepSORT-based object tracking model, and the determining module includes:

a second determining unit configured to determine candidate box information and the first re-identification feature of each target object based on a pre-trained object detection network model, the candidate box information including candidate box position information;

a second encoding unit configured to encode a candidate box position corresponding to each target object based on the

TransFormer encoder network, to obtain a position coding feature of each target object; and

a second fusing unit configured to fuse the position coding feature and the first re-identification feature of each target object to obtain the object re-identification feature of each target object.

The embodiment of the present disclosure provides a possible implementation, in which the determining module is specifically configured to determine the first re-identification feature of each target object in the target frame image using an object tracking model based on combined detection and tracking.

The embodiment of the present disclosure provides a possible implementation, in which the object tracking model based on combined detection and tracking is a FairMORT-based object tracking model, and the determining module includes:

a third determining unit configured to extract the first re-identification feature and a detection feature of each target object via a pre-trained encoder-decoder network of the FairMOT-based object tracking model;

an estimating unit configured to perform Heatmap estimation based on each of the detection feature to obtain the center point position of each target object;

a third encoding unit configured to encode the center point position of each target object based on the TransFormer encoder network, to obtain a position coding feature of each target object; and

a third fusing unit configured to fuse the position coding feature and the first re-identification feature of each target object to obtain the object re-identification feature of each target object.

The embodiment of the present disclosure achieves the same beneficial effects as the above method embodiments. The description will not be repeated here.

In the technical solution of the present disclosure, the collection, storage, use, processing, transfer, provision, and disclosure of personal information of a user involved are in conformity with relevant laws and regulations, and do not violate public order and good customs.

According to an embodiment of the present disclosure, the present disclosure further provides an electronic device, a readable storage medium, and a computer program product.

The electronic device includes: at least one processor; and a memory communicatively connected to the at least one processor; where the memory stores instructions executable by the at least one processor, and the instructions are executed by the at least one processor, such that the at least one processor can execute the method provided in embodiments of the present disclosure.

A re-identification feature used for data association between the electronic device and object tracking in an existing technology is an appearance feature. The present disclosure determines an object re-identification feature of each target object in a target frame image, the object re-identification feature including position information of the target object; and performs object tracking based on the object re-identification feature of each target object. That is, the re-identification feature used for data association in object tracking includes position information of the target object, thereby improving the differentiation degree between the target object and the background, and reducing, for target objects with similar appearances, the occurrence of incorrect ID switch during object tracking due to consideration of the position information of the target objects. For example, for target objects A and B with similar appearances, correct IDs of the target objects A and B are 23 and 24, respectively. Since A and B have similar appearances, an incorrect ID switch may occur during data association, because a re-identification feature of the target object A is likely to successfully match a historical re-identification feature of a tracker corresponding to the ID of 24, and a re-identification feature of the target object B is likely to successfully match a historical re-identification feature of a tracker corresponding to the ID of 23, i.e., the ID of the target object A is determined to be 24, and the ID of the target object B is determined to be 23. The re-identification feature used for data association in the present disclosure introduces position features of the target objects, thereby reducing the occurrence of incorrect ID switch.

The readable storage medium is a non-transient computer readable storage medium storing computer instructions, where the computer instructions are used for causing a computer to execute the method provided in the embodiments of the present disclosure.

A re-identification feature used for data association between the readable storage medium and object tracking in an existing technology is the appearance feature. The present disclosure determines an object re-identification feature of each target object in a target frame image, the object re-identification feature including position information of the target object; and performs object tracking based on the object re-identification feature of each target object. That is, the re-identification feature used for data association in object tracking includes position information of the target object, thereby improving the differentiation degree between the target object and the background, and reducing, for target objects with similar appearances, the occurrence of incorrect ID switch during object tracking due to consideration of the position information of the target objects. For example, for target objects A and B with similar appearances, correct IDs of the target objects A and B are 23 and 24, respectively. Since A and B have similar appearances, an incorrect ID switch may occur during data association, because a re-identification feature of the target object A is likely to successfully match a historical re-identification feature of a tracker corresponding to the ID of 24, and a re-identification feature of the target object B is likely to successfully match a historical re-identification feature of a tracker corresponding to the ID of 23, i.e., the ID of the target object A is determined to be 24, and the ID of the target object B is determined to be 23. The re-identification feature used for data association in the present disclosure introduces position features of the target objects, thereby reducing the occurrence of incorrect ID switch.

The computer program product includes a computer program, where the computer program, when executed by a processor, implements the method as shown in the first aspect of the present disclosure.

A re-identification feature used for data association between the computer program product and object tracking in an existing technology is the appearance feature. The present disclosure determines an object re-identification feature of each target object in a target frame image, the object re-identification feature including position information of the target object; and performs object tracking based on the object re-identification feature of each target object. That is, the re-identification feature used for data association in object tracking includes position information of the target object, thereby improving the differentiation degree between the target object and the background, and reducing, for target objects with similar appearances, the occurrence of incorrect ID switch during object tracking due to consideration of the position information of the target objects. For example, for target objects A and B with similar appearances, correct IDs of the target objects A and B are 23 and 24, respectively. Since A and B have similar appearances, an incorrect ID switch may occur during data association, because a re-identification feature of the target object A is likely to successfully match a historical re-identification feature of a tracker corresponding to the ID of 24, and a re-identification feature of the target object B is likely to successfully match a historical re-identification feature of a tracker corresponding to the ID of 23, i.e., the ID of the target object A is determined to be 24, and the ID of the target object B is determined to be 23. The re-identification feature used for data association in the present disclosure introduces position features of the target objects, thereby reducing the occurrence of incorrect ID switch.

FIG. 3 shows a schematic block diagram of an example electronic device 300 that may be configured to implement embodiments of the present disclosure. The electronic device is intended to represent various forms of digital computers, such as a laptop computer, a desktop computer, a workbench, a personal digital assistant, a server, a blade server, a mainframe computer, and other suitable computers. The electronic device may also represent various forms of mobile apparatuses, such as a personal digital assistant, a cellular phone, a smart phone, a wearable device, and other similar computing apparatuses. The components shown herein, the connections and relationships thereof, and the functions thereof are used as examples only, and are not intended to limit implementations of the present disclosure described and/or claimed herein.

As shown in FIG. 3, the device 300 includes a computing unit 301, which may execute various appropriate actions and processes in accordance with a computer program stored in a read-only memory (ROM) 302 or a computer program loaded into a random-access memory (RAM) 303 from a storage unit 308. The RAM 303 may further store various programs and data required by operations of the device 300. The computing unit 301, the ROM 302, and the RAM 303 are connected to each other through a bus 304. An input/output (I/O) interface 307 is also connected to the bus 304.

A plurality of components in the device 300 is connected to the I/O interface 305, including: an input unit 306, such as a keyboard and a mouse; an output unit 307, such as various types of displays and speakers; a storage unit 308, such as a magnetic disk and an optical disk; and a communication unit 309, such as a network card, a modem, and a wireless communication transceiver. The communication unit 309 allows the device 300 to exchange information/data with other devices via a computer network such as the Internet and/or various telecommunication networks.

The computing unit 301 may be various general-purpose and/or special-purpose processing components having a processing power and a computing power. Some examples of the computing unit 301 include, but are not limited to, a central-processing unit (CPU), a graphics processing unit (GPU), various special-purpose artificial intelligence (AI) computing chips, various computing units running a machine learning model algorithm, a digital signal processor (DSP), and any appropriate processor, controller, micro-controller, and the like. The computing unit 301 executes various methods and processes described above, such as the method for tracking an object. For example, in some embodiments, the method for tracking an object may be implemented as a computer software program that is tangibly included in a machine readable medium, such as the storage unit 308. In some embodiments, some or all of the computer programs may be loaded and/or installed onto the device 300 via the ROM 302 and/or the communication unit 309. When the computer program is loaded into the RAM 303 and executed by the computing unit 301, one or more steps of the method for tracking an object described above may be executed. Alternatively, in other embodiments, the computing unit 301 may be configured to execute the method for tracking an object by any other appropriate approach (e.g., by means of firmware).

Various implementations of the systems and technologies described above herein may be implemented in a digital electronic circuit system, an integrated circuit system, a field programmable gate array (FPGA), an application specific integrated circuit (ASIC), an application specific standard product (ASSP), a system on a chip (SOC), a complex programmable logic device (CPLD), computer hardware, firmware, software, and/or a combination thereof. The various implementations may include: an implementation in one or more computer programs that are executable and/or interpretable on a programmable system including at least one programmable processor, which may be a special-purpose or general-purpose programmable processor, and may receive data and instructions from, and transmit data and instructions to, a storage system, at least one input apparatus, and at least one output apparatus.

Program codes for implementing the method of the present disclosure may be compiled using any combination of one or more programming languages. The program codes may be provided to a processor or controller of a general-purpose computer, a special-purpose computer, or other programmable data processing apparatuses, such that the program codes, when executed by the processor or controller, cause the functions/operations specified in the flowcharts and/or block diagrams to be implemented. The program codes may be completely executed on a machine, partially executed on a machine, executed as a separate software package on a machine and partially executed on a remote machine, or completely executed on a remote machine or server.

In the context of the present disclosure, the machine readable medium may be a tangible medium which may contain or store a program for use by, or used in combination with, an instruction execution system, apparatus or device. The machine readable medium may be a machine readable signal medium or a machine readable storage medium. The computer readable medium may include, but is not limited to, electronic, magnetic, optical, electromagnetic, infrared, or semiconductor systems, apparatuses, or devices, or any appropriate combination of the above. A more specific example of the machine readable storage medium will include an electrical connection based on one or more pieces of wire, a portable computer disk, a hard disk, a random-access memory (RAM), a read only memory (ROM), an erasable programmable read only memory (EPROM or flash memory), an optical fiber, a portable compact disk read only memory (CD-ROM), an optical memory device, a magnetic memory device, or any appropriate combination of the above.

To provide interaction with a user, the systems and technologies described herein may be implemented on a computer that is provided with: a display apparatus (e.g., a CRT (cathode ray tube) or a LCD (liquid crystal display) monitor) configured to display information to the user; and a keyboard and a pointing apparatus (e.g., a mouse or a trackball) by which the user can provide an input to the computer. Other kinds of apparatuses may also be configured to provide interaction with the user. For example, feedback provided to the user may be any form of sensory feedback (e.g., visual feedback, auditory feedback, or haptic feedback); and an input may be received from the user in any form (including an acoustic input, a voice input, or a tactile input).

The systems and technologies described herein may be implemented in a computing system (e.g., as a data server) that includes a back-end component, or a computing system (e.g., an application server) that includes a middleware component, or a computing system (e.g., a user computer with a graphical user interface or a web browser through which the user can interact with an implementation of the systems and technologies described herein) that includes a front-end component, or a computing system that includes any combination of such a back-end component, such a middleware component, or such a front-end component. The components of the system may be interconnected by digital data communication (e.g., a communication network) in any form or medium. Examples of the communication network include: a local area network (LAN), a wide area network (WAN), and the Internet.

The computer system may include a client and a server. The client and the server are generally remote from each other, and usually interact via a communication network. The relationship between the client and the server arises by virtue of computer programs that run on corresponding computers and have a client-server relationship with each other. The server may be a cloud server, a distributed system server, or a server combined with a blockchain.

It should be understood that the various forms of processes shown above may be used to reorder, add, or delete steps. For example, the steps disclosed in the present disclosure may be executed in parallel, sequentially, or in different orders, as long as the desired results of the technical solution disclosed in the present disclosure can be implemented. This is not limited herein.

The above specific implementations do not constitute any limitation to the scope of protection of the present disclosure. It should be understood by those skilled in the art that various modifications, combinations, sub-combinations, and replacements may be made according to the design requirements and other factors. Any modification, equivalent replacement, improvement, and the like made within the spirit and principle of the present disclosure should be encompassed within the scope of protection of the present disclosure.

What is claimed is:

1. A method for tracking an object, comprising:
determining an object re-identification feature of each target object in a target frame image, the object re-identification feature comprising position information of a target object; and
performing object tracking based on the object re-identification feature of each target object.

2. The method according to claim 1, wherein the position information of the target object is center point information of the target object.

3. The method according to claim 2, wherein determining the object re-identification feature of each target object in the target frame image comprises:
determining a first re-identification feature of each target object in the target frame image, the first re-identification feature comprising a visual feature and/or a motion feature;
encoding a center point position of each target object based on a TransFormer encoder network, to obtain a center point coding feature of each target object; and
performing fusing on the center point coding feature and the first re-identification feature of each target object to obtain the object re-identification feature of each target object.

4. The method according to claim 3, wherein the method comprises:
determining the first re-identification feature of each target object in the target frame image using a model of object tracking by detecting.

5. The method according to claim 4, wherein the model of object tracking by detecting is a DeepSORT-based object tracking model, and the method comprises:
determining candidate box information and the first re-identification feature of each target object based on a pre-trained object detection network model, the candidate box information comprising candidate box position information;
encoding a candidate box position corresponding to each target object based on the TransFormer encoder network, to obtain a position coding feature of each target object; and
performing fusing on the position coding feature and the first re-identification feature of each target object to obtain the object re-identification feature of each target object.

6. The method according to claim 3, wherein the method further comprises:
determining the first re-identification feature of each target object in the target frame image using an object tracking model based on combined detection and tracking.

7. The method according to claim 6, wherein the object tracking model based on combined detection and tracking is a FairMOT-based object tracking model, and the method further comprises:
extracting the first re-identification feature and a detection feature of each target object via a pre-trained encoder-decoder network of the FairMOT-based object tracking model;
performing Heatmap estimation based on each detection feature to obtain the center point position of each target object;
encoding the center point position of each target object based on the TransFormer encoder network, to obtain a position coding feature of each target object; and
performing fusing on the position coding feature and the first re-identification feature of each target object to obtain the object re-identification feature of each target object.

8. An apparatus for tracking an object, comprising:
at least one processor; and
a memory storing instructions, wherein the instructions when executed by the at least one processor, cause the at least one processor to perform operations, the operations comprising:
determining an object re-identification feature of each target object in a target frame image, the object re-identification feature comprising position information of a target object; and
performing object tracking based on the object re-identification feature of each target object.

9. The apparatus according to claim 8, wherein the position information of the target object is center point information of the target object.

10. The apparatus according to claim 9, wherein the operations further comprise:
determining a first re-identification feature of each target object in the target frame image, the first re-identification feature comprising a visual feature and/or a motion feature;
encoding a center point position of each target object based on a TransFormer encoder network, to obtain a center point coding feature of each target object; and
performing fusing on the center point coding feature and the first re-identification feature of each target object to obtain the object re-identification feature of each target object.

11. The apparatus according to claim 10, wherein the operations further comprise: determining the first re-identification feature of each target object in the target frame image using a model of object tracking by detecting.

12. The apparatus according to claim 11, wherein the model of object tracking by detecting is a DeepSORT-based object tracking model, and the operations further comprise:
determining candidate box information and the first re-identification feature of each target object based on a pre-trained object detection network model, the candidate box information comprising candidate box position information;
encoding a candidate box position corresponding to each target object based on the TransFormer encoder network, to obtain a position coding feature of each target object; and
performing fusing on the position coding feature and the first re-identification feature of each target object to obtain the object re-identification feature of each target object.

13. The apparatus according to claim 10, wherein the operations further comprise: determining the first re-identification feature of each target object in the target frame image using an object tracking model based on combined detection and tracking.

14. The apparatus according to claim 13, wherein the object tracking model based on combined detection and tracking is a FairMOT-based object tracking model, and the operations further comprise:
extracting the first re-identification feature and a detection feature of each target object via a pre-trained encoder-decoder network of the FairMOT-based object tracking model;
performing Heatmap estimation based on each of the detection feature to obtain the center point position of each target object;
encoding the center point position of each target object based on the TransFormer encoder network, to obtain a position coding feature of each target object; and
performing fusing on the position coding feature and the first re-identification feature of each target object to obtain the object re-identification feature of each target object.

15. A non-transitory computer readable storage medium storing computer instructions, wherein the computer instructions are used for causing a computer to execute operations comprising:
determining an object re-identification feature of each target object in a target frame image, the object re-identification feature comprising position information of a target object; and
performing object tracking based on the object re-identification feature of each target object.

16. The non-transitory computer readable storage medium according to claim 15, wherein the position information of the target object is center point information of the target object.

17. The non-transitory computer readable storage medium according to claim 16, wherein determining the object re-identification feature of each target object in the target frame image comprises:
determining a first re-identification feature of each target object in the target frame image, the first re-identification feature comprising a visual feature and/or a motion feature;
encoding a center point position of each target object based on a TransFormer encoder network, to obtain a center point coding feature of each target object; and
performing fusing on the center point coding feature and the first re-identification feature of each target object to obtain the object re-identification feature of each target object.

18. The non-transitory computer readable storage medium according to claim 17, wherein the operations further comprise:
determining the first re-identification feature of each target object in the target frame image using a model of object tracking by detecting.

19. The non-transitory computer readable storage medium according to claim 18, wherein the model of object tracking by detecting is a DeepSORT-based object tracking model, and the operations further comprise:
determining candidate box information and the first re-identification feature of each target object based on a pre-trained object detection network model, the candidate box information comprising candidate box position information;
encoding a candidate box position corresponding to each target object based on the TransFormer encoder network, to obtain a position coding feature of each target object; and
performing fusing on the position coding feature and the first re-identification feature of each target object to obtain the object re-identification feature of each target object.

20. The non-transitory computer readable storage medium according to claim 18, wherein the operations further comprise:
determining the first re-identification feature of each target object in the target frame image using an object tracking model based on combined detection and tracking.
